(19) United States
(12) Patent Application Publication
(10) Pub. No.: US 2018/0114618 A1
(43) Pub. Date: Apr. 26, 2018

(54) MAGNETIC MIXTURE, GREEN BODY OF MAGNETIC ELEMENT, MAGNETIC ELEMENT AND MANUFACTURING METHOD OF THE MAGNETIC ELEMENT

(71) Applicant: SUMIDA CORPORATION, Tokyo (JP)

(72) Inventor: Kazuhisa SATO, Natori City (JP)

(21) Appl. No.: 15/794,455

(22) Filed: Oct. 26, 2017

(30) Foreign Application Priority Data
Oct. 26, 2016 (JP) 2016-209992

(51) Int. Cl. H01F 3/08; H01F 41/02

(52) U.S. Cl. CPC H01F 3/08; H01F 41/0246

(57) ABSTRACT

A magnetic mixture composed by mixing a putty material containing a magnetic-material powder and a binder resin, and a solvent in which a weight of the magnetic-material powder is contained by a ratio of 89.2 wt % or more and 96.1 wt % or less with respect to a total weight of the putty material and concurrently, in which a weight of the binder resin is contained by a ratio of 2.9 wt % or more and 6.9 wt % or less with respect to the total weight of the putty material, wherein there is employed a configuration in which the solvent is selected to have a boiling point of 200° C. or more and 300° C. or less and concurrently, a weight of the solvent is to be contained by a ratio of 1.0 wt % or more and 3.9 wt % or less with respect to the total weight of the putty material.

### CROSS REFERENCES TO RELATED APPLICATIONS

The present invention claims priority under 35 U.S.C. § 119 to Japanese Patent Application 2016-209992 filed Oct. 26, 2016, the entire contents of which being incorporated herein by reference.

### BACKGROUND OF THE INVENTION

### Field of the Invention

The present invention relates to a magnetic mixture, an green body of a magnetic element, a magnetic element and a manufacturing method of the magnetic element, which are used for a magnetic element such as an inductor or the like.

### Description of the Related Art

For a magnetic element such as an inductor or the like, there has been known a magnetic element which includes, for example, a coil component wound by using a metal conductor having an insulation coating and a core containing that coil component, in which that core is composed of a mixture of a magnetic powder and a resin.

For the technical method of creating the abovementioned core, there has been known a technology of creating a core composed of a powder compression molding core by pressing a magnetic mixture which contains various kinds of magnetic-material powders. With regard to such a technology, for example, a Patent Document 1 (Japanese unexamined patent publication No. S63-271905) discloses a powder compression molding core which is composed of an Fe—Si—Al-based alloy powder. When creating such a powder compression molding core, pressurization is applied by using an extremely large molding pressure, for example, of 5 to 15 ton/cm² force and therefore, the abovementioned alloy powders are retained in a mutually tight state. Meanwhile, in recent years, various kinds of tests have been carried out in order to improve the performance of such a magnetic-element product.

For example, with respect to a magnetic element mounted by solder reflow, it has been required to judge the existence and/or non-existence of crack occurrence of the product, to measure the inductance change-rate of the product, and so on depending on an MSL (Moisture Sensitivity Level) test.

More specifically, in that MSL-test, for example, under a condition that a predetermined number of magnetic elements per one lot are made to be samples and they are retained for a long time in a constant-temperature bath having a high temperature state and thereafter, they are further made to pass through a reflow layer having a high temperature, various kinds of measurements are carried out, wherein as a result thereof, when a crack occurs even at one single sample, when the inductance change-rate becomes a ratio having a predetermined value or more and so on, there sometimes happens that all the magnetic elements in this lot become the disposal target.

### SUMMARY OF THE INVENTION

However, for the reason that the powder compression molding core constituting the abovementioned core is retained in a tight state as mentioned above and therefore, the vaporized moisture will be confined therein and when the magnetic element is set to have a high temperature state in the MSL-test, the moisture contained in the fusion-bond layer or the like within the coil component evaporates so that a large internal pressure is generated in the inside of the core, which will cause the core expand, and a crack occur.

Therefore, as to the result of the MSL-test which judges whether there is a problem or not in the magnetic element, the moisture entered into the inside of the magnetic element may have a significant influence.

The present invention was invented in view of the abovementioned situation and is addressed to provide a magnetic mixture, an green body of a magnetic element, a magnetic element and a manufacturing method of the magnetic element, wherein even in a case of arranging a magnetic element formed by embedding a coil component in the inside of a magnetic core produced by the compression-molding of the magnetic-material powders under a high-temperature environment, it is possible to prevent such a phenomenon in which a crack occurs at that magnetic element, the inductance change-rate varies largely beyond a predetermined value, and so on.

The magnetic mixture of the present invention is characterized by being composed by mixing a putty material containing a binder resin and a magnetic-material powder, and a solvent, in which a weight of the magnetic-material powder is contained by a ratio of 89.2 wt % or more and 96.1 wt % or less with respect to a total weight of the putty material and concurrently, in which a weight of the binder resin is contained by a ratio of 2.9 wt % or more and 6.9 wt % or less with respect to the total weight of the putty material, wherein there is employed a configuration in which the solvent is selected to have a boiling point of 200° C. or more and 300° C. or less and concurrently, a weight of the solvent is to be contained by a ratio of 1.0 wt % or more and 3.9 wt % or less with respect to the total weight of the putty material.

It is preferable that the weight of the solvent is constituted so as to be contained by a ratio of 1.5 wt % or more and 3.0 wt % or less with respect to the total weight of the putty material.

In addition, it is preferable for an green body of a magnetic element according to the present invention to include a coil component, and any one of the aforementioned magnetic mixtures, which is formed by being embedded with that coil component.

In addition, the magnetic element of the present invention is characterized by including a coil component, and a magnetic core which is embedded with that coil component and which is formed by curing a putty material containing a magnetic-material powder and a binder resin, wherein the magnetic element is manufactured by a manufacturing method comprising the steps of:

mixing the magnetic-material powder, the binder resin and a solvent for producing a magnetic mixture such that a weight of the magnetic-material powder is contained by a ratio of 89.2 wt % or more and 96.1 wt % or less with respect to a total weight of the putty material and concurrently, such that a weight of the binder resin is contained by a ratio of 2.9 wt % or more and 6.9 wt % or less with respect to the total weight of the putty material and also, a weight of the solvent which is selected to have a boiling point of 200° C. or more and 300° C. or less is contained by a ratio of 1.0 wt % or more and 3.9 wt % or less with respect to the total weight of the putty material;

embedding the coil component in the inside of the magnetic mixture after said step of mixing is ended; and

curing the magnetic mixture by heating and evaporating the solvent under a temperature equal to or less than the boiling point of that solvent after said step of embedding is ended.

In addition, in this case, it is preferable that for the weight ratios of the magnetic-material powder, the binder resin and the solvent which are mixed in said step of mixing, the weight of the magnetic-material powder is selected to be in a ratio of 91.5 wt % or more and 95.0 wt % or less with respect to the total weight of the putty material, the weight of the binder resin is selected to be in a ratio of 3.5 wt % or more and 5.5 wt % or less with respect to the total weight of the putty material, and the weight of the solvent is selected to be in a ratio of 1.5 wt % or more and 3.0 wt % or less with respect to the total weight of the putty material.

In addition, the manufacturing method of the magnetic element of the present invention is characterized by including a coil component, and a magnetic core which is embedded with that coil component and which is formed by curing a putty material containing a magnetic-material powder and a binder resin, comprising the steps of:

mixing the magnetic-material powder, the binder resin and a solvent for producing a magnetic mixture such that a weight of the magnetic-material powder is contained by a ratio of 89.2 wt % or more and 96.1 wt % or less with respect to a total weight of the putty material and concurrently, such that a weight of the binder resin is contained by a ratio of 2.9 wt % or more and 6.9 wt % or less with respect to the total weight of the putty material and also, a weight of the solvent which is selected to have a boiling point of 200° C. or more and 300° C. or less is contained by a ratio of 1.0 wt % or more and 3.9 wt % or less with respect to the total weight of the putty material;

embedding the coil component in the inside of the magnetic mixture after said step of mixing is ended; and

curing the magnetic mixture by heating and evaporating the solvent under a temperature equal to or less than the boiling point of that solvent after said step of embedding is ended.

In addition, it is possible that in said step of embedding, the coil component is put into the inside of a mold body and thereafter, the magnetic mixture is put into the inside of the mold body in which the magnetic mixture is pressed, and the coil component is embedded in the inside of the magnetic mixture.

Meanwhile, in the present invention, as mentioned above, for a magnetic element which is formed by embedding a coil component into the inside of a magnetic mixture, the magnetic mixture is formed by mixing a magnetic-material powder, a resin material and a solvent having a boiling point of 200° C. to 300° C. by a predetermined weight ratio and a magnetic core is created by thermosetting the magnetic mixture, in which it is possible to evaporate the solvent at the time of that thermosetting. Therefore, it is possible to produce a lot of pore-shaped air-holes (hereinafter, referred to simply as pores) in the inside of the magnetic core in which the magnetic mixture is cured and it is possible to set the gas-transmittance of the magnetic element to be a predetermined value or more. Thus, even in a case of placing a magnetic element, in which a core is produced, for example by a powder compression molding processing of a magnetic-material powder, under a high-temperature environment of the MSL-test or the like, the internal pressure will never increase extremely, and it is possible to prevent cracks from occurring in that magnetic element, which may cause the inductance change-rate varies largely beyond a predetermined value and so on.

In a case of placing a conventional magnetic element under a high-temperature environment after the moisture absorption in the MSL-test or the like, there was obtained such a state in which the internal pressure increases extremely, a crack occurs at that magnetic element, the inductance change-rate varies largely beyond a predetermined value, and so on.

Under such a situation, it is difficult to maintain the magnetic property of the magnetic element in an excellent state.

The difference between the present invention and the prior-art technology is considered to be caused largely by the influence of the fact whether or not the magnetic-material powder, the resin material, and the solvent having a boiling point of 200° C. to 300° C. were mixed by the predetermined weight ratio, speaking more simply, whether or not it was possible to produce predetermined pores in the inside of the magnetic core caused by the phenomenon that there is contained the solvent having a boiling point of 200° C. to 300° C. by a predetermined ratio and that the solvent is evaporated at the time of the thermosetting, in which the gas-transmittance thereof will change drastically depending on the number of these pores and depending on the diameter size and the shape of the pore and therefore, it is impossible to flatly specify the structure or the property relating to that difference by using a certain wording.

On the other hand, with regard to differences in the number of the pores and in the diameter size and the shape of the pore, which relate to the present invention and the prior-art technology, it is possible in principle to carry out the measurement by using an electronic microscope, a pore-distribution measuring apparatus or the like, and actually, if in a case of one or two magnetic elements, it is possible to measure the differences, but in a case of manufacturing or purchasing the magnetic elements of the present invention and of the prior-art technology respectively as many as the numbers which become statistically significant and in a case of measuring the numerical features by the electronic microscope or the pore-distribution measuring apparatus, there must be found out significant indexes and the values thereof for distinguishing the present invention and the prior-art technology under a condition of finishing those statistical processings, in which it should be recognized that it takes enormous time and cost. Furthermore, with regard to the prior-art technology, there is a possibility that a tremendous number of prior-art exists and therefore, it is also impossible to uniquely determine the number which becomes statistically significant.

To find out the indexes and the values thereof as mentioned above and then to specify the features of the present invention directly by the structure or the property of the device depending on that found-out fact are not practical at all.

Then, with regard to the magnetic elements relating to claims 4 and 5, the present applicant tried to express those claims, unavoidably, according to the description-style of claims which are connected with the inventions of device-manufacturing methods.

According to the magnetic element and the manufacturing method of the magnetic element implementing the present invention, there are employed the aforementioned respective constituent elements and the solvent having a boiling point of 200° C. to 300° C. is evaporated at the time of the thermosetting of the magnetic mixture and therefore, it is conceivable that it is possible, relying on that configuration, to produce a large number of pores in the inside of the magnetic core in which the magnetic mixture is cured and thus, it is possible to set the gas-transmittance of the magnetic element to be a predetermined value or more. Thus, even in a case of placing the magnetic element in which the core is produced by the powder compression molding processing of the magnetic-material powder under a high-temperature environment of the MSL-test or the like, the internal pressure never increases extremely and it is possible to prevent such a state in which a crack occurs at that magnetic element, the inductance change-rate varies largely beyond a predetermined value, and so on.

In addition, according to the magnetic mixture and the green body of the magnetic element implementing the present invention, the magnetic mixture is formed by mixing a magnetic-material powder, a resin material and a solvent having a boiling point of 200° C. to 300° C. by a predetermined weight ratio and that solvent is evaporated at the time of the thermosetting of the magnetic mixture and therefore, it is conceivable that it is possible, relying on that configuration, to produce a large number of pores in the inside of the magnetic core in which the magnetic mixture is cured and thus, it is possible to set the gas-transmittance of the magnetic element to be a predetermined value or more.

From this fact, according to the magnetic mixture, the green body of the magnetic element, the magnetic element and the manufacturing method of the magnetic element, which implement the present invention, it is possible to prevent the deterioration of the property of the magnetic element.

### BRIEF DESCRIPTION OF THE DRAWINGS

FIG. 1 is a perspective view showing a magnetic element relating to an exemplified embodiment of the present invention by seeing-through the element;

FIG. 2 is a cross-section view at A-A line of the magnetic element shown in FIG. 1;

FIG. 3 is a ternary phase diagram showing weight ratios of magnetic-material powder, binder resin and solvent in a magnetic mixture of the present exemplified embodiment; and

FIGS. 4A, 4B and 4C are schematic constitutional views for sequentially explaining a manufacturing method of the magnetic element relating to the present exemplified embodiment.

### DESCRIPTION OF THE PREFERRED EMBODIMENTS

Hereinafter, there will be explained a basic constitution of a magnetic element relating to one exemplified embodiment of the present invention based on the drawings.

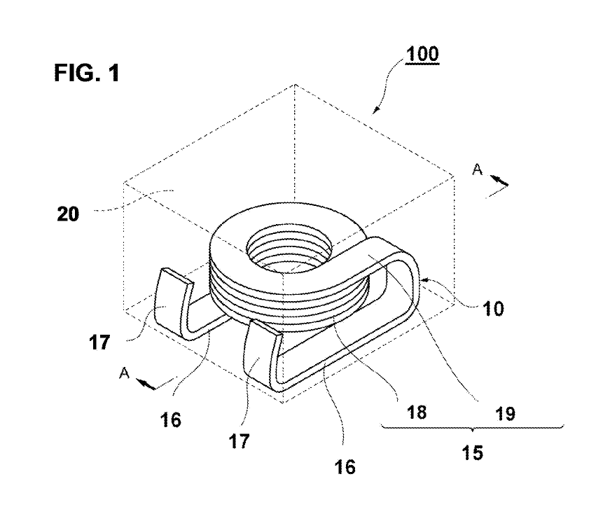

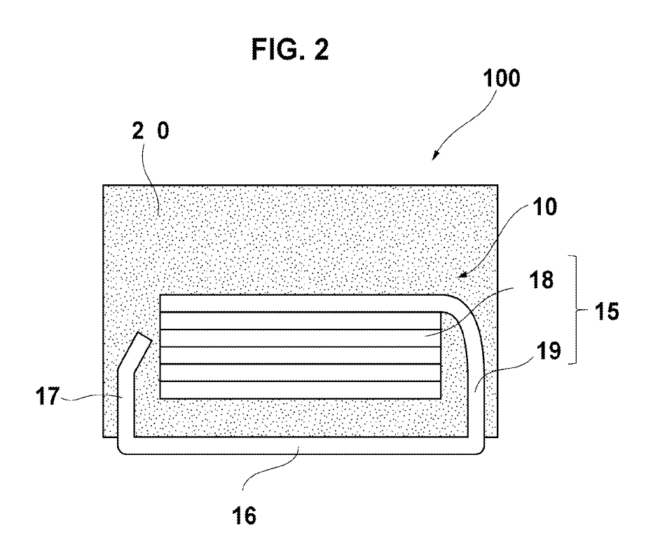

FIG. 1 is a perspective view showing a constitution of a magnetic element 100 relating to the present exemplified embodiment. FIG. 2 is a cross-section view at A-A line in FIG. 1, which shows an inside constitution of the magnetic element 100 of the present exemplified embodiment.

With regard to the magnetic element 100 shown in FIG. 1, for the sake of convenience in viewability, a magnetic core 20 is indicated by broken lines and a coil component 10 covered by the magnetic core 20 is indicated by real lines. In FIG. 2, the cross-section of the magnetic core 20 is indicated by pearskin finish and the coil component 10 is made to be in an outlined-figure state. In addition, the coil component 10 is indicated by a simple shape for the sake of convenience for explanation, in which in order to obtain shape stability of the coil component itself, it is possible to use a base member or a support member which is composed of a magnetic body.

The coil component 10 in the present exemplified embodiment is an electronic component in which inductance occurs in a coil 15 by a power supply applied by way of a terminal portion 16 for the surface-mounting from a substrate which is not shown and specifically, the coil component is an inductor, a transformer, a choke coil or the like. For the coil component 10 of the present exemplified embodiment, for the sake of simplifying the explanation thereof, an inductor having a single winding is exemplified as a representative example.

The magnetic element 100 is formed by a configuration in which the coil component 10 composed of the coil 15 is embedded in the inside of the magnetic core 20. The magnetic core 20 is formed by mixing and thermosetting a magnetic-material powder and a thermosetting resin (binder resin), and the coil 15 is composed of a winding portion 18 and a non-winding portion 19. In addition, for the non-winding portion 19, there is provided a terminal portion 16 for being surface-mounted onto the substrate or the like and there is provided a final end portion 17 which is bent in order to hold the coil 15 onto the magnetic core 20.

Specifically, the magnetic-material powder is a soft-magnetic metal powder and from the view point of, for example, the magnetic property, availability or the like, it is preferable to employ Fe-based metal powders, in which among those kinds of powders, it is particularly preferable to employ Fe—Si—Al-based powder (sendust), Fe—Ni-based powder (permalloy), Fe—Co-based powder (permendur), Fe—Si—Cr-based powder, powders of Fe—Si-based silicon steel and Fe-based amorphous, or the like. In addition, it is also possible to use a mixture which is composed by mixing two or more kinds of those magnetic-material powders.

Even among those powders, in order to obtain better magnetic property, it is preferable to use the Fe—Si—Cr-based powder. It should be noted that the particle size of the magnetic-material powder is selected, for example, to be 5 μm to 30 μm. In addition, there is no limitation particularly for the particle shape of the magnetic-material powder and it is possible to select a substantially-spherical shape, a plate shape or the like appropriately depending on the use-purpose thereof.

In addition, for the binder resin, there can be cited, for example, silicon resin, epoxy resin, PES (polyethersulfone) resin, PAI (polyamide-imide) resin, PEEK (polyether ether ketone) resin, phenol resin or the like, but it is possible to use resins other than those above for the binder resin. From the view point of easiness of availability, the heat-resisting property or the like, it is particularly preferable to employ silicon resin and epoxy resin.

In addition, in a case of forming the magnetic core 20 by the putty material composed of a magnetic-material powder and a binder resin in a manner as mentioned above, the magnetic core is constituted such that the weight ratio of the magnetic-material powder occupying the total putty material (magnetic core 20) becomes 89.2 wt % or more and 96.1 wt % or less, and such that the weight ratio of the binder resin occupying the aforesaid total putty material (magnetic core 20) becomes 2.9 wt % or more and 6.9 wt % or less. It should be noted that the putty material means a molding material having a certain viscosity and hardness and is a material which does not have adequate fluidity but which has a property deformable by a low molding force.

By employing such a constitution, it is possible to obtain such an excellent effect in which it is possible to obtain a property as a putty material and also it is possible to obtain a desired inductance value satisfying the product property.

When the weight ratio of the magnetic-material powder occupying the total putty material (magnetic core 20) becomes less than 89.2 wt %, it happens that the inductance value decreases and it becomes difficult to satisfy the product property.

On the other hand, when the weight ratio of the magnetic-material powder occupying the total putty material (magnetic core 20) becomes more than 96.1 wt %, it becomes difficult to obtain a property as a putty material.

In addition, when the weight ratio of the binder resin occupying the total putty material (magnetic core 20) becomes less than 2.9 wt %, it becomes difficult to obtain a property as a putty material.

On the other hand, when the weight ratio of the binder resin occupying the total putty material (magnetic core 20) becomes more than 6.9 wt %, the gas-transmittance becomes too low and it becomes difficult to clear the MSL1 (moisture level 1).

It should be noted that if the weight ratio of the magnetic-material powder occupying the total putty material (magnetic core 20) is in a range of 94.0 wt % or more and 95.5 wt % or less, it is possible to promote such an effect mentioned above, in which it is possible to obtain a property as a putty material and also it is possible to obtain a desired inductance value satisfying the product property, to become better and therefore, this situation is more preferable.

In addition, if the weight ratio of the binder resin occupying the total putty material (magnetic core 20) is in a range of 3.5 wt % or more and 5.5 wt % or less, it is possible to promote such an effect, in which it is possible to obtain a property as a putty material and also it is possible to obtain a desired gas-transmittance which can clear the MSL1, to become better and this situation is more preferable.

Meanwhile, as mentioned above, the abovementioned magnetic element 100 is formed by embedding the coil component 10 composed of the coil 15 in the inside the magnetic core 20. Then, this magnetic core 20 is formed by a core made by mixing a magnetic-material powder and a thermosetting resin (binder resin), in which a feature of the present invention lies in that at the time of manufacturing the magnetic core 20, the magnetic mixture created by mixing the magnetic-material powder, the binder resin and the solvent by the aforementioned ratio is heated and the solvent is evaporated, and concurrently, the mixture is thermally-cured for producing the magnetic core 20.

More specifically, the finally obtained magnetic core 20 is made to be in a handling-capable state in which the magnetic-material powder and the binder resin are mixed, and in the initial stage of the manufacturing, there is obtained a state of the magnetic mixture in which the putty material formed by kneading the magnetic-material powder and the binder resin in a clay state and the solvent are mixed, and thereafter, at the time of the heat treatment in the curing process, the evaporation of the solvent is promoted in which owing to the evaporation of that solvent, a handling-capable magnetic core 20 is produced. At that time, a large number of pores are formed in the inside of the magnetic core 20 and therefore, the gas-transmittance increases to 500 cm³·mm/(m²·sec·atm) or more.

It should be noted that it is necessary for the abovementioned solvent to be a solvent having a boiling point of 200° C. to 300° C. This is because when the boiling point is lower than 200° C., such a problem will occur that in order to cure the binder resin material, it happens that the solvent will be boiled at a stroke when the temperature is raised up to the curing temperature thereof, and in addition, this is because when the boiling point is higher than 300° C., there occurs such an inconvenience that the solvent is to remain after the thermosetting.

For a specific example of the aforementioned solvent having a boiling point of 200° C. to 300° C., there can be cited diethyl phthalate, ethylcarbitol, butylcarbitol, methyltriglycol, diethylene-glycol-monohexyl-ether, diethylene-glycol-monobutyl-ether-acetate, diethylene-glycol, diethylene-glycol-dibutyl-ether, dimethoxy-tetraethylene-glycol, 1,3-butanediol, and 1,4-butanediol.

The abovementioned magnetic mixture uses a solvent having a boiling point of 200° C. to 300° C. and the mixture is produced by mixing the magnetic-material powder, the binder resin constituting the putty material (sticky material like clay), and in addition, by mixing the abovementioned solvent such that the weight ratio of the abovementioned solvent with respect to the abovementioned putty material becomes 1.0 wt % or more and 3.9 wt % or less.

By employing such a configuration, it is possible to obtain a property as a putty material and it is possible to obtain such an excellent effect that it is possible to obtain a desired gas-transmittance which can clear the MSL1.

When the weight ratio of the abovementioned solvent with respect to the putty material (magnetic core 20) becomes less than 1.0 wt %, there occurs such a problem that it is not possible to obtain a property as a putty material or it is not possible to obtain a desired gas-transmittance which can clear the MSL1.

On the other hand, when the weight ratio of the abovementioned solvent with respect to the putty material (magnetic core 20) becomes more than 3.9 wt %, it is not possible to obtain a property as a putty material, in which it happens that there will be obtained a paste state or a slurry state.

Further, if the weight ratio of the abovementioned solvent with respect to the putty material (magnetic core 20) is made to be 1.5 wt % or more and 3.0 wt % or less, it is possible to promote such an effect mentioned above, in which it is possible to obtain a property as a putty material and it is possible to obtain a desired gas-transmittance which can clear the MSL1, to become better and therefore, this situation is more preferable.

It should be noted that the configuration is designed, as mentioned above, such that the weight ratio of the magnetic-material powder occupying the total putty material (magnetic core 20) becomes 89.2 wt % or more and 96.1 wt % or less and in addition, such that the weight ratio of the binder resin occupying the total putty material (magnetic core 20) becomes 2.9 wt % or more and 6.9 wt % or less.

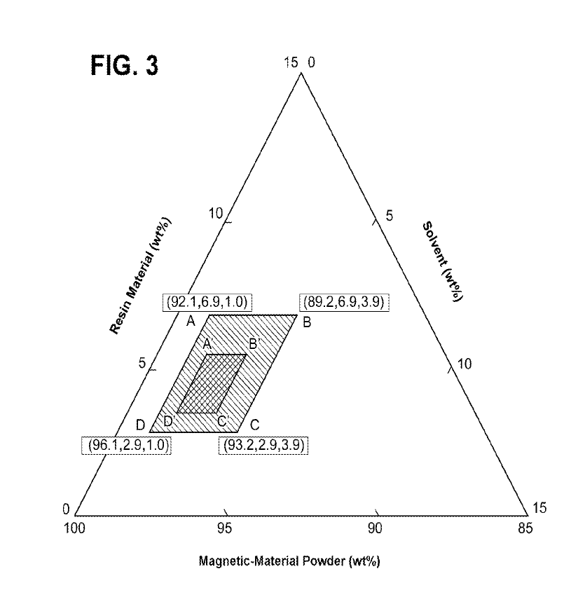

When drawing the weight ratios of the magnetic-material powder, the binder resin (resin material) and the solvent which are constituted in this manner in a ternary phase diagram, there can be obtained a diagram shown in FIG. 3.

More specifically, the weight ratios of those elements are set to be positioned within a rectangular area indicated in FIG. 3 by a hatched-area which has vertexes defined by a point “A” (magnetic-material powder: 92.1%, resin material: 6.9%, solvent: 1.0%), a point “B” (magnetic-material powder: 89.2%, resin material: 6.9%, solvent: 3.9%), a point “C” (magnetic-material powder: 93.2%, resin material: 2.9%, solvent: 3.9%) and a point “D” (magnetic-material powder: 96.1%, resin material: 2.9%, solvent: 1.0%).

As mentioned above, by setting the ratios of the abovementioned three elements to fall into the rectangular area indicated by the hatched-area, even in a case of positioning the magnetic element 100 formed by a configuration in which the coil component 10 is embedded in the inside the magnetic core 20 formed by curing the magnetic mixture 50 under such a high-temperature environment as an MSL test chamber or the like, it is possible to prevent the occurrence of such a state in which a crack occurs at this magnetic element 100, the inductance change-rate varies largely beyond a predetermined value, and so on. Thus, it is possible to prevent the property-deterioration of the magnetic element 100.

It should be noted that if setting the weight ratios of the abovementioned three elements so as to be positioned within a rectangular area indicated in FIG. 3 by a cross-hatched-area which has vertexes defined by a point “A′” (magnetic-material powder: 93.0%, resin material: 5.5%, solvent: 1.5%), a point “B′” (magnetic-material powder: 91.5%, resin material: 5.5%, solvent: 3.0%), a point “C′” (magnetic-material powder: 93.5%, resin material: 3.5%, solvent: 3.0%) and a point “D′” (magnetic-material powder: 95.0%, resin material: 3.5%, solvent: 1.5%), it is possible to more heighten the effect of preventing the property-deterioration of the aforementioned magnetic element 100.

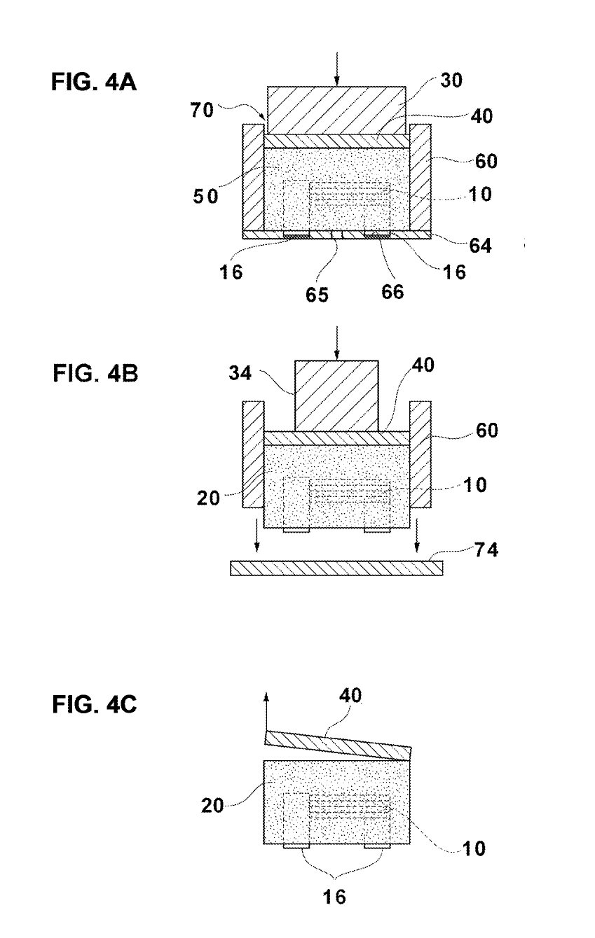

The coil component 10 and the magnetic mixture 50 are put into the inside of a mold body 60 (see FIG. 4A) such that the magnetic mixture 50 constituted in this manner is embedded by surrounding the coil component 10, this magnetic mixture 50 is pressed flatly from the upper side by, for example, a pressing body 30 (see FIG. 4A), this coil component 10 is embedded in the inside of this magnetic mixture 50, and based on this configuration, an green body of the magnetic element 100 is produced.

Next, there will be explained a manufacturing method of the magnetic element 100 relating to the present exemplified embodiment.

There will be explained respective processes in this manufacturing method by using FIGS. 4A, 4B and 4C. It should be noted in those drawings that for the coil component 10 and the magnetic mixture 50 (magnetic core 20), there are shown the cross-sections thereof, but the illustrations of the hatchings showing the cross-sections are omitted therein.

First, by using a planetary mixer, a magnetic-material powder (for example, Fe—Si—Cr (sendust)-based powder), a binder resin (resin material: for example, epoxy resin or silicon resin) and a solvent (for example, diethyl phthalate) are mixed so as to be uniformly dispersed by the predetermined weight ratios mentioned above and a magnetic mixture 50 is created and is kept and maintained in a predetermined container (Mixing Process).

In addition, a coil component 10 to be embedded in the abovementioned magnetic mixture 50 is prepared. This coil component 10 is molded to have such a shape that when being embedded in the magnetic mixture 50 (magnetic core 20), the non-winding portion 19 of the coil 15 is bent so as to go toward the bottom side of the magnetic core 20 as shown in FIGS. 1 and 2, in which the non-winding portion is bent so as to go along the bottom surface of the magnetic element 100 on the outside of the magnetic core 20 and is made to function as a terminal for the surface-mounting, and in which the final end portion 17 is bent so as to be inserted again into the inside of the magnetic core 20. Thus, it is possible to obtain a formation as a magnetic element 100 of surface-mounting type.

Next, there will be prepared a mold body 60 and a lid body 40 (Mold Body & Lid Body Preparing Process). The lid body 40 prevents the pressing body 30 from being directly attached to the magnetic mixture 50 (magnetic core 20), and also, is a mold-release sheet which can be peeled off easily from the magnetic core 20 after the thermosetting.

It is preferable for the lid body 40 composed of a mold-release sheet to be formed by a resin material excellent in mold-release property and, for example, it is possible to use a fluorine resin material such as polytetrafluoroethylene (PTFE) or the like. There is no limitation in particular for the thickness of the lid body 40 and it is allowed to employ a lid body having a plate-shape, a block-shape or the like other than a so-called sheet-shape. The lid body 40 forms approximately the same shape as that of the cross-section of the opening portion 70 of the mold-body (mold) 60 and has substantially the same size. Thus, it is possible to arrange the lid body 40 in the inside of the opening portion 70 without any gap.

Next, the coil component 10 is put into the hollow portion in the inside of the mold body 60 and the terminal portion 16 of the non-winding portion 19 is made to fit with a concave portion 66 of the bottom portion 64. Next, the magnetic mixture 50 which is produced in the abovementioned mixing process and which is measured to have a predetermined amount is put thereinto up to a little bit lower portion of the opening portion 70.

The magnetic mixture 50 which was put there-into by doing as mentioned above is flattened by a spatular tool (not shown) or the like if necessary and thereafter, as shown in FIG. 4A, the lid body 40 is placed on the surface of the magnetic mixture 50. Subsequently, the pressing body 30 is lowered without substantial rotation and the lid body 40 is pressed downward (Pressing Process). When the magnetic mixture 50 is pushed adequately into the mold body 60, there is obtained a state in which the coil component 10 is embedded securely in the inside of the magnetic mixture 50 (Embedding Process). Thereafter, the pressing body 30 is lifted without rotation. The reason for moving the pressing body 30 upward and downward without rotation is because of preventing a phenomenon in which the lid body 40 is deformed by a friction force with respect to the pressing body 30.

Next, the magnetic mixture 50 which is pressed into the inside of the mold body 60 is taken out from the mold body 60 together with the coil component 10. Specifically, as shown in FIG. 4B, the magnetic mixture 50 and the coil component 10 are pushed down from the upper side of the mold body 60 by using a pushing-out member 34 or the like. At that time, the magnetic element 100 which is made to be uncured in a state just before a thermosetting process which will be mentioned later is referred to as an green body.

Next, the magnetic mixture 50 is taken-out and thermally-cured and the magnetic core 20 is molded (Curing Process). When thermally-curing the magnetic mixture 50, the curing is carried out by placing the magnetic mixture 50 and the coil component 10, for example, on a heat-resistance tray 74. Thereafter, when the thermosetting processing of the magnetic core 20 is finished, the lid body 40 is peeled off from the magnetic core 20 after removing the heat if necessary.

As shown by an arrow in FIG. 4C, it is allowed for one side of the rectangular-shaped lid body 40 to be formed with a peeling-gripper (not shown) such that the lid body 40 can be peeled off easily from the magnetic core 20. It is possible to form the peeling-gripper by applying a notch to one side of the lid body 40 a little bit or by applying a folding-back thereto. Thus, the manufacturing processes of the magnetic element 100 are finished.

Next, there will be explained an inventive example relating to the magnetic element 100 of the present invention.

### Inventive Example

In this inventive example, for the magnetic-material powder, Fe—Si—Cr-based powder is used, in addition, for the binder resin, epoxy resin is used and further, for the solvent, diethyl phthalate is used, in which by mixing those materials by using a planetary mixer, there is obtained a magnetic mixture (Mixing Process).

Thereafter, by using the mold body 60 such as the aforementioned exemplified embodiment, the coil component 10 is embedded in the inside of the magnetic mixture 50 (Embedding Process), the magnetic mixture is cured by being heated with a temperature (180° C.) lower than the boiling point of the solvent (Curing Process), and owing to these processes, there was obtained a sample of the magnetic element 100 which has the magnetic core 20.

It should be noted that, with regard to the coil component 10, polyamide-imide is used for the insulation layer thereof and a fusion cupper wire employing the thermoplastic resin as the material thereof is used for the fusion-bond layer, in which the coil component 10 is formed by winding the coil thereof as many as 16.5 turns in a state that the inner diameter becomes 4.5 mm and the outer diameter becomes 8.0 mm. It should be noted that with regard to the outer size of the magnetic core 20 at that time, the vertical size thereof is selected to be 10 mm, the horizontal size thereof is selected to be 10 mm and the thickness thereof is selected to be 5 mm.

With respect to samples of such a magnetic element 100, various kinds of measurements were carried out by variously changing the weight ratio of the magnetic-material powder, the weight ratio of the binder resin and the weight ratio of the solvent. At that time, there were measured the gas-transmittances of the magnetic cores 20 of the formed magnetic elements 100.

It should be noted that the weight of the magnetic core 20 of the molded-body, the weight of the binder resin and the weight of the solvent were measured by using an electronic balance.

In addition, for the measurement of the gas-transmittance, there was used a publicly known gas-transmittance measuring device which was constituted by abutting two molds and which was disclosed in the Specification and Drawings of the Japanese unexamined patent publication No. 2016-171115 previously filed by the present applicant.

It should be noted that the measurement of the gas-transmittance was carried out under an indoor environment. The gas-transmittance was made to be expressed by cm³·mm/(m²·sec·atm).

It should be noted that with regard to the product inductance (Ls), there was carried out the measurement by a well-known measuring method.

In addition, the MSL-test carried out with respect to the magnetic element 100 was carried out under such a condition that the magnetic element was kept in a 125° C.-test-chamber for 24 hours (in which moisture was removed), thereafter, was kept in an 85° C.-85%-test-chamber for 168 hours (in which water was absorbed) and was passed through a reflow furnace whose maximum temperature is 260 degrees.

For the specific items, there were measured the ratio by which the crack occurred (crack occurrence-rate) at the outer appearance of the magnetic core 20, and the change-rate of the inductance value (L).

From the result of this measurement, a judgment “acceptable” was applied when the crack occurrence-rate was 0 (in Table-1 mentioned later, a mark “0” was applied in the judgement column of the crack occurrence-rate) and when the crack occurrence-rate was larger than 0 (when a crack occurs even a little bit), a judgment “unacceptable” was applied (in Table-1 mentioned later, a mark “X” was applied in the judgement column of the crack occurrence-rate. In addition, with regard to the change-rate of the inductance value (L), a judgment “acceptable” was applied when the change-rate falls within ±5% (−5%≤(change-rate of L)≤5%) (in Table-1 mentioned later, a mark “∘” was applied in the judgement column of the inductance change-rate) and when the change-rate of the inductance value (L) does not fall within ±5% ((change-rate of L)<−5% or (change-rate of L)>5%), a judgment “unacceptable” was applied (in Table-1 mentioned later, a mark “X” was applied in the judgement column of the inductance change-rate).

In addition, there were carried out measurements also with regard to a drop test of the magnetic element 100 and with regard to the shape retention thereof. More specifically, with regard to the drop test of the magnetic element 100, the magnetic element 100 was dropped from a height of 100 cm and there was carried out a measurement about whether or not the magnetic element is damaged. On the other hand, with regard to the shape retention of the magnetic element 100, there was carried out a measurement in such a view point about whether or not the molded-body of the magnetic element 100 is handling-capable. More specifically, the shape retention means an index relating to whether or not the magnetic element can be self-independent without being deformed even after a certain period of time elapsed when the aforesaid green body was not supported.

From the result of this measurement, with regard to the drop test, a judgment “acceptable” was applied when the breakage rate was 0 (in Table-1 mentioned later, a mark “0” was applied in the judgement column of the drop test) and when the breakage rate was larger than 0 (when the breakage occurs even a little bit), a judgment “unacceptable” was applied (in Table-1 mentioned later, a mark “X” was applied in the judgement column of the drop test). In addition, with regard to the shape retention, a judgment “acceptable” was applied when the molded-body of the magnetic element 100 was handling-capable (in Table-1 mentioned later, a mark “∘” was applied in the judgement column of the drop test) and when it was difficult to handle the magnetic core 20, a judgment “unacceptable” was applied (in Table-1 mentioned later, a mark “X” was applied in the judgement column of the shape retention).

Then, there was carried out a comprehensive judgement based on the aforementioned respective items. With regard to the comprehensive judgement, there was applied “Final Acceptable Product” when judgments “acceptable” were applied for all the measurement items (in Table-1 mentioned later, a mark “∘” was applied in the judgement column of the comprehensive judgement) and was made to be a final unacceptable product when even one measurement item was unacceptable (in Table-1 mentioned later, a mark “X” was applied in the judgement column of the comprehensive judgement).

The Table-1 below is a table shown by wrapping up the results with regard to such respective items.

It should be noted in this Table-1 that with regard to the inventive examples 1 to 19, there are made the settings, as mentioned above, such that: (1) the weight ratio of the magnetic-material powder occupying the total putty material (magnetic core 20) becomes in the range of 89.2 wt % or more and 96.1 wt % or less; (2) the weight ratio of the binder resin occupying the total putty material (magnetic core 20) becomes in the range of 2.9 wt % or more and 6.9 wt % or less; and further, (3) the weight ratio of the solvent with respect to the putty material (magnetic core 20) becomes in the range of 1.0 wt % or more and 3.9 wt % or less, in which every one of the inventive examples falls within the hatched-area of the ternary phase diagram which is shown in FIG. 3.

On the other hand, with regard to the comparative examples 1 to 28, there is not satisfied at least one condition within the aforementioned conditions (1), (2) and (3), so that every one of the comparative examples is positioned on the outside of the hatched-area of the ternary phase diagram which is shown in FIG. 3.

TABLE 1

| Composition (wt %) | | | Gas- | MSL | | | | | | | |
|---|---|---|---|---|---|---|---|---|---|---|---|
| magnetic- | | | transmittance | crack | | inductance | | | judgement | | |
| material | resin | | cm3 · mm/ | occurrence | judge- | change- | judge- | judgement | of shape- | comprehensive | |
| powder | material | solvent | (m2 · sec · atm) | rate (%) | ment | rate (%) | ment | of drop-test | retention | judgement | Remarks |
| 99.0 | 1.0 | 0.0 | 3000 | 0 | ∘ | −4 | ∘ | x | ∘ | x | Comparative |
| | | | | | | | | | | | Example 1 |
| 98.0 | 2.0 | 0.0 | 2000 | 0 | ∘ | −4 | ∘ | x | ∘ | x | Comparative |
| | | | | | | | | | | | Example 2 |
| 97.0 | 3.0 | 0.0 | 150 | 80 | x | −18 | x | ∘ | ∘ | x | Comparative |
| | | | | | | | | | | | Example 3 |
| 96.5 | 3.0 | 0.5 | 270 | 70 | x | −17 | x | ∘ | ∘ | x | Comparative |
| | | | | | | | | | | | Example 4 |
| 96.1 | 2.9 | 1.0 | 1500 | 0 | ∘ | −2 | ∘ | ∘ | ∘ | ∘ | Inventive |
| | | | | | | | | | | | Example 1 |
| 95.6 | 2.9 | 1.5 | 3500 | 0 | ∘ | −4 | ∘ | ∘ | ∘ | ∘ | Inventive |
| | | | | | | | | | | | Example 2 |
| 93.7 | 2.9 | 3.4 | 9000 | 0 | ∘ | −2 | ∘ | ∘ | ∘ | ∘ | Inventive |
| | | | | | | | | | | | Example 3 |
| 93.3 | 2.9 | 3.8 | 10000 | 0 | ∘ | −2 | ∘ | ∘ | ∘ | ∘ | Inventive |
| | | | | | | | | | | | Example 4 |
| 93.1 | 2.9 | 4.0 | 12000 | | | | | | x | x | Comparative |
| | | | | | | | | | | | Example 5 |
| 93.0 | 2.8 | 4.2 | 14000 | | | | | | x | x | Comparative |
| | | | | | | | | | | | Example 6 |
| 96.0 | 4.0 | 0.0 | 120 | 94 | x | −19 | x | ∘ | ∘ | x | Comparative |
| | | | | | | | | | | | Example 7 |
| 95.5 | 4.0 | 0.5 | 230 | 85 | x | −20 | x | ∘ | ∘ | x | Comparative |
| | | | | | | | | | | | Example 8 |
| 95.0 | 4.0 | 1.0 | 1000 | 0 | ∘ | −4 | ∘ | ∘ | ∘ | ∘ | Inventive |
| | | | | | | | | | | | Example 5 |
| 92.8 | 3.9 | 3.4 | 8000 | 0 | ∘ | −4 | ∘ | ∘ | ∘ | ∘ | Inventive |
| | | | | | | | | | | | Example 6 |
| 92.3 | 3.8 | 3.9 | 9000 | 0 | ∘ | −2 | ∘ | ∘ | ∘ | ∘ | Inventive |
| | | | | | | | | | | | Example 7 |
| 92.1 | 3.8 | 4.1 | 10000 | | | | | | x | x | Comparative |
| | | | | | | | | | | | Example 9 |
| 92.0 | 3.7 | 4.2 | 12000 | | | | | | x | x | Comparative |
| | | | | | | | | | | | Example 10 |
| 95.0 | 5.0 | 0.0 | 80 | 98 | x | −18 | x | ∘ | ∘ | x | Comparative |
| | | | | | | | | | | | Example 11 |
| 94.5 | 5.0 | 0.5 | 200 | 92 | x | −20 | x | ∘ | ∘ | x | Comparative |
| | | | | | | | | | | | Example 12 |
| 94.1 | 5.0 | 1.0 | 800 | 0 | ∘ | −4 | ∘ | ∘ | ∘ | ∘ | Inventive |
| | | | | | | | | | | | Example 8 |
| 93.6 | 4.9 | 1.5 | 2000 | 0 | ∘ | −4 | ∘ | ∘ | ∘ | ∘ | Inventive |
| | | | | | | | | | | | Example 9 |
| 91.8 | 4.8 | 3.4 | 6000 | 0 | ∘ | −3 | ∘ | ∘ | ∘ | ∘ | Inventive |
| | | | | | | | | | | | Example 10 |
| 91.3 | 4.8 | 3.8 | 7000 | 0 | ∘ | −2 | ∘ | ∘ | ∘ | ∘ | Inventive |
| | | | | | | | | | | | Example 11 |
| 91.2 | 4.8 | 4.0 | 8000 | | | | | | x | x | Comparative |
| | | | | | | | | | | | Example 13 |
| 91.1 | 4.7 | 4.2 | 9000 | | | | | | x | x | Comparative |
| | | | | | | | | | | | Example 14 |
| 94.0 | 6.0 | 0.0 | 50 | 100 | x | −23 | x | ∘ | ∘ | x | Comparative |
| | | | | | | | | | | | Example 15 |
| 93.5 | 6.0 | 0.5 | 150 | 93 | x | −18 | x | ∘ | ∘ | x | Comparative |
| | | | | | | | | | | | Example 16 |
| 93.1 | 5.9 | 1.0 | 600 | 0 | ∘ | 0 | ∘ | ∘ | ∘ | ∘ | Inventive |
| | | | | | | | | | | | Example 12 |
| 92.6 | 5.9 | 1.5 | 1000 | 0 | ∘ | −4 | ∘ | ∘ | ∘ | ∘ | Inventive |
| | | | | | | | | | | | Example 13 |
| 90.8 | 5.8 | 3.4 | 4000 | 0 | ∘ | −4 | ∘ | ∘ | ∘ | ∘ | Inventive |
| | | | | | | | | | | | Example 14 |
| 90.4 | 5.8 | 3.8 | 6000 | 0 | ∘ | −4 | ∘ | ∘ | ∘ | ∘ | Inventive |
| | | | | | | | | | | | Example 15 |
| 90.2 | 5.8 | 4.0 | 7000 | | | | | | x | x | Comparative |
| | | | | | | | | | | | Example 17 |
| 90.1 | 5.7 | 4.2 | 8000 | | | | | | x | x | Comparative |
| | | | | | | | | | | | Example 18 |
| 93.0 | 7.0 | 0.0 | 30 | 100 | x | −21 | x | ∘ | ∘ | x | Comparative |
| | | | | | | | | | | | Example 19 |
| 92.5 | 7.0 | 0.5 | 100 | 98 | x | −19 | x | ∘ | ∘ | x | Comparative |
| | | | | | | | | | | | Example 20 |
| 92.1 | 6.9 | 1.0 | 500 | 0 | ∘ | 0 | ∘ | ∘ | ∘ | ∘ | Inventive |
| | | | | | | | | | | | Example 16 |
| 91.6 | 6.9 | 1.5 | 1000 | 0 | ∘ | −4 | ∘ | ∘ | ∘ | ∘ | Inventive |
| | | | | | | | | | | | Example 17 |
| 91.2 | 6.9 | 2.0 | 1500 | 0 | ∘ | −4 | ∘ | ∘ | ∘ | ∘ | Inventive |
| | | | | | | | | | | | Example 18 |
| 89.4 | 6.7 | 3.8 | 5000 | 0 | ∘ | −4 | ∘ | ∘ | ∘ | ∘ | Inventive |
| | | | | | | | | | | | Example 19 |
| 89.3 | 6.7 | 4.0 | 6000 | | | | | | x | x | Comparative |
| | | | | | | | | | | | Example 21 |
| 89.2 | 6.6 | 4.2 | 7000 | | | | | | x | x | Comparative |
| | | | | | | | | | | | Example 22 |
| 92.0 | 8.0 | 0.0 | 10 | 100 | x | −21 | x | ∘ | ∘ | x | Comparative |
| | | | | | | | | | | | Example 23 |
| 91.5 | 8.0 | 0.5 | 50 | 98 | x | −19 | x | ∘ | ∘ | x | Comparative |
| | | | | | | | | | | | Example 24 |
| 91.1 | 7.9 | 1.0 | 300 | | | | | | x | x | Comparative |
| | | | | | | | | | | | Example 25 |
| 90.6 | 7.9 | 1.5 | 700 | | | | | | x | x | Comparative |
| | | | | | | | | | | | Example 26 |
| 88.9 | 7.7 | 3.4 | 2000 | | | | | | x | x | Comparative |
| | | | | | | | | | | | Example 27 |
| 88.5 | 7.7 | 3.8 | 3000 | | | | | | x | x | Comparative |
| | | | | | | | | | | | Example 28 |

As clear from the abovementioned Table-1, in the inventive examples 1 to 19, all of the judgements of “acceptable” were applied not only with regard to the judgements relating to the change-rate of the crack occurrence-rate and the inductance value (L) in the MSL-test but also with regard to the drop test judgement and the shape retention judgement, in which there was obtained a result that the comprehensive judgements of “acceptable” were applied thereto (in Table-1, marks of “∘” were applied in the judgement columns of the comprehensive judgement).

In addition, the gas-transmittance closely relates to the weight ratio of the solvent which is contained in the magnetic mixture 50 and in each of the inventive examples 1 to 19, it becomes a state in which the gas-transmittance is at least 500 cm³·mm/(m²·sec·atm) (see Inventive Example 16).

On the other hand, when the weight ratio of the solvent which is contained in the magnetic mixture 50 is 0.5 wt % which is less than 1.0 wt %, it becomes a state in which the gas-transmittance is 270 cm³·mm/(m²·sec·atm) even if maximum (see the case of Comparative Example 4).

When the weight ratio of the solvent becomes 1.0 wt % or more and in a case of forming the magnetic core 20 by thermosetting the magnetic mixture 50, there occurs, in the inside of the this magnetic core 20, pores which pass-through the gas, caused by the evaporation of that solvent and thereafter, in a case of carrying out the MSL-test and when the confined moisture becomes water vapor and also evaporates, it is possible to discharge the water vapor toward the outside of the magnetic core 20 through those pores.

Thus, it is conceivable, in particular, that the crack occurrence-rate in the MSL-test became excellent.

On the other hand, when the weight ratio of the solvent becomes less than 1.0 wt % and in a case of forming the magnetic core 20 by thermosetting the magnetic mixture 50, the evaporation amount of that solvent is little and therefore, there are not formed, in the inside of that this magnetic core 20, adequate pores which pass-through the gas. Therefore, in a case of carrying out the MSL-test thereafter, also when the confined moisture becomes water vapor and evaporates, the phenomenon of discharging the water vapor toward the outside of the magnetic core 20 through those pores becomes imperfect. Thus, it is conceivable, in particular, that there was obtained the judgement “unacceptable” for the aspect of the crack occurrence-rate in the MSL-test.

Therefore, the fact whether the weight ratio of the solvent is 1.0 wt % or is less than that ratio (for example, 0.5 wt %) causes a large difference for the gas-transmittance and it is conceivable, according to this fact, that a large difference occurs for the crack occurrence-rate at the time of the MSL-test.

In addition, by setting the weight ratio of the solvent to fall into the range of 1.5 wt % or more and 3.0 wt % or less with respect to the putty material (magnetic core 20), it is possible to improve the gas-transmittance remarkably while maintaining the judgements for other items to be excellent and therefore, this situation is more preferable.

In addition, when the weight ratio of the solvent with respect to the putty material (magnetic core 20) exceeds 3.9 wt %, the shape retention is deteriorated extremely and further, even if the weight ratio of the solvent with respect to the putty material (magnetic core 20) is in the range of 1.0 wt % or more and 3.9 wt % or less, the weight ratio of the magnetic-material powder occupying the total putty material (magnetic core 20) becomes 91.1 wt % or less, and also, when the weight ratio of the binder resin occupying the total putty material (magnetic core 20) becomes 7.7 wt % or more, the shape retention is deteriorated extremely.

When the shape retention is deteriorated extremely in this manner, it is not possible to carry out the crack occurrence-rate judgement and the inductance change-rate judgement in the MSL-test and further, it is not possible to carry out the drop test. For this reason, slanted lines are applied to the corresponding positional-columns in Table-1.

Further, as shown in Table-1, when the weight ratio of the binder resin occupying the total putty material (magnetic core 20) becomes 2.0 wt % or less, the magnetic core 20 loses elasticity and it becomes in a fragile state and therefore, the product strength becomes insufficient and the judgement of drop test falls into a judgement “unacceptable”. For this reason, the comprehensive judgement also falls into a judgement “unacceptable”.

According to the magnetic element 100 explained above, the magnetic mixture 50 for forming the magnetic core 20 is formed by mixing a putty material containing a magnetic-material powder and a binder resin, and a solvent having a boiling point of 200° C. or more and 300° C. or less so as to be contained by a ratio of 1.0 wt % or more and 3.9 wt % or less with respect to the total weight of the putty material; the aforesaid magnetic-material powder is configured so as to be contained by a ratio of 89.2 wt % or more and 96.1 wt % or less with respect to the total weight of the putty material; in addition, the binder resin is configured so as to be contained by a ratio of 2.9 wt % or more and 6.9 wt % or less with respect to the total weight of the aforesaid putty material; and in this magnetic core 20, the coil component 20 which is formed by winding the coil 15 is embedded.

For that reason, even under a high-temperature environment under which the MSL-test is carried out, it is easily possible to discharge the water vapor caused by the moisture, which is contained in the insulation layer and the fusion-bond layer of the coil 15, in addition, the water vapor which is contained in the inside of magnetic core 20 and in addition, the water vapor which is contained in the coil 15 itself, toward the outside of the magnetic element 100 through the pores which are formed in the magnetic core 20.

Thus, under a high-temperature environment such as of the MSL-test or the like, it is possible to prevent the defect in which the magnetic core 20 is expanded, a crack occurs at the magnetic core 20, and so on.

In addition, the occurrence of a crack or the like is prevented in the magnetic core 20 and therefore, it is possible to prevent the defect in which the inductance of the magnetic element 100 decreases.

It should be noted that the aforementioned magnetic-material powder, binder resin and solvent are not to be limited by those of the abovementioned inventive examples and it is possible to replace them by various kinds of members or the like which are cited in the aforementioned exemplified embodiment.

For example, it is possible for the binder resin to use another resin such as a silicon resin or the like instead of the epoxy resin.

In addition, the magnetic mixture, the green body of the magnetic element 100, the magnetic element 100 and the manufacturing method of the magnetic element 100 of the present invention are not to be limited by those of the abovementioned exemplified embodiment and it is possible to replace them by other various kinds of embodiments so far as satisfying the gist of the present invention.

For example, in the aforementioned exemplified embodiment, there is shown such an expression that the magnetic mixture is formed by a magnetic-material powder, a binder resin and a solvent, but it is also possible to employ a constitution which includes additional another element other than those three elements.

In addition, in the abovementioned exemplified embodiment, there is employed such a configuration that for the embedding process, a coil component is first put into a mold body and thereafter, a magnetic mixture is put thereinto and by pressing the magnetic mixture from the upper side of the mold body, the coil component is embedded in the inside of the magnetic mixture, but it is allowed to employ such a configuration that the magnetic mixture is put into the mold body in advance and thereafter, the coil component is put thereinto, and by employing such a configuration of pressing the coil component toward the inside of the magnetic mixture, the coil component is to be embedded into the inside of the magnetic mixture.

In addition, in the aforementioned exemplified embodiment, there is formed a magnetic core 20 having a desired gas-transmittance by compression-molding (press-molding) the mixture of the magnetic-material powder and the binder resin. However, it is allowed to form the magnetic core 20 by a manufacturing method other than the compression-molding method.

In addition, in the aforementioned exemplified embodiment, the magnetic element 100 was explained by citing an inductor as an example, but instead of this example, it is allowed to employ an example in which the present invention is applied to another magnetic element such as a transformer or the like.

In addition, the coil component 10 which is embedded in the inside of the magnetic core 20 is not limited by the component having the shape shown in FIGS. 1 and 2, and for example, it is also allowed to employ a component which has such a shape that a core-shaped magnetic material is arranged in the coil hollow portion or a plate-shaped magnetic material is arranged at the coil bottom portion.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A magnetic mixture composed by mixing a putty material containing a binder resin and a magnetic-material powder, and a solvent,
in which a weight of the magnetic-material powder is contained by a ratio of 89.2 wt % or more and 96.1 wt % or less with respect to a total weight of the putty material and concurrently, in which a weight of the binder resin is contained by a ratio of 2.9 wt % or more and 6.9 wt % or less with respect to the total weight of the putty material, wherein
there is employed a configuration in which the solvent is selected to have a boiling point of 200° C. or more and 300° C. or less and concurrently, a weight of the solvent is to be contained by a ratio of 1.0 wt % or more and 3.9 wt % or less with respect to the total weight of the putty material.

2. The magnetic mixture according to claim 1, wherein the weight of the solvent is constituted so as to be contained by a ratio of 1.5 wt % or more and 3.0 wt % or less with respect to the total weight of the putty material.

3. A green body of a magnetic element comprising: a coil component, and the magnetic mixture according to claim 1 which is formed by being embedded with that coil component.

4. A magnetic element including a coil component, and a magnetic core which is embedded with that coil component and which is formed by curing a putty material containing a magnetic-material powder and a binder resin, wherein the magnetic element is manufactured by a manufacturing method comprising the steps of:
mixing the magnetic-material powder, the binder resin and a solvent for producing a magnetic mixture such that a weight of the magnetic-material powder is contained by a ratio of 89.2 wt % or more and 96.1 wt % or less with respect to a total weight of the putty material and concurrently, such that a weight of the binder resin is contained by a ratio of 2.9 wt % or more and 6.9 wt % or less with respect to the total weight of the putty material and also, a weight of the solvent which is selected to have a boiling point of 200° C. or more and 300° C. or less is contained by a ratio of 1.0 wt % or more and 3.9 wt % or less with respect to the total weight of the putty material;
embedding the coil component in the inside of the magnetic mixture after said step of mixing is ended; and
curing the magnetic mixture by heating and evaporating the solvent under a temperature equal to or less than the boiling point of that solvent after said step of embedding is ended.

5. The magnetic element according to claim 4, wherein for the weight ratios of the magnetic-material powder, the binder resin and the solvent which are mixed in said step of mixing, the weight of the magnetic-material powder is selected to be in a ratio of 91.5 wt % or more and 95.0 wt % or less with respect to the total weight of the putty material, the weight of the binder resin is selected to be in a ratio of 3.5 wt % or more and 5.5 wt % or less with respect to the total weight of the putty material, and the weight of the solvent is selected to be in a ratio of 1.5 wt % or more and 3.0 wt % or less with respect to the total weight of the putty material.

6. A manufacturing method of a magnetic element including a coil component, and a magnetic core which is embedded with that coil component and which is formed by curing a putty material containing a magnetic-material powder and a binder resin, comprising the steps of:
mixing the magnetic-material powder, the binder resin and a solvent for producing a magnetic mixture such that a weight of the magnetic-material powder is contained by a ratio of 89.2 wt % or more and 96.1 wt % or less with respect to the total weight of the putty material and concurrently, such that a weight of the binder resin is contained by a ratio of 2.9 wt % or more and 6.9 wt % or less with respect to the total weight of the putty material and also, a weight of the solvent which is selected to have a boiling point of 200° C. or more and 300° C. or less is contained by a ratio of 1.0 wt % or more and 3.9 wt % or less with respect to the total weight of the putty material;
embedding the coil component in the inside of the magnetic mixture after said step of mixing is ended; and
curing the magnetic mixture by heating and evaporating the solvent under a temperature equal to or less than the boiling point of that solvent after said step of embedding is ended.

7. The manufacturing method of a magnetic element according to claim 6, wherein in said step of embedding, the coil component is put into the inside of a mold body and thereafter, the magnetic mixture is put into the inside of the mold body in which the magnetic mixture is pressed, and the coil component is embedded in the inside of the magnetic mixture.
